(19) United States
(12) Patent Application Publication
(10) Pub. No.: US 2006/0071902 A1
(43) Pub. Date: Apr. 6, 2006

(54) Electrophoretic display panel and driving method therefor

(75) Inventors: Guofu Zhou, Eindhoven (NL); Mark Thomas Johnson, Eindhoven (NL); Willibrordus Jurrianus Dijkman, Eindhoven (NL); Rogier Hendrikus Magdalena Cortie, Eindhoven (NL); Albert Geven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/542,910

(22) PCT Filed: Dec. 24, 2003
(86) PCT No.: PCT/IB03/06340

§ 371 Date: Jul. 20, 2005

(30) Foreign Application Priority Data
Jan. 23, 2003 (EP) 03100133.2

(51) Int. Cl. G09G 3/34

(52) U.S. Cl. 345/107

(57) ABSTRACT

The electrophoretic display panel (1), for displaying a picture corresponding to image information, has drive means (100) which are arranged for controlling the potential difference of each picture element (2) to be a reset potential difference having a reset value and a reset duration for enabling particles (6) to substantially occupy one of the extreme positions, and subsequently to be a picture potential difference for enabling the particles (6) to occupy the position corresponding to the image information. For the display panel (1) to be able to provide a relatively high picture quality, the drive means (100) are further arranged for controlling the reset potential difference of each picture element (2) of at least a number of the picture elements (2) to have an additional reset duration.

The invention relates to an electrophoretic display panel, for displaying a picture corresponding to image information, comprising:
an electrophoretic medium comprising charged particles;
a plurality of picture elements;
a first and a second electrode associated with each picture element for receiving a potential difference; and
drive means,
   the charged particles being able to occupy a position being one of extreme positions near the electrodes and intermediate positions in between the electrodes for displaying the picture, and the drive means being arranged for controlling the potential difference of each picture element
to be a reset potential difference having a reset value and a reset duration for enabling particles to substantially occupy one of the extreme positions, and subsequently
to be a picture potential difference for enabling the particles to occupy the position corresponding to the image information.

An embodiment of the electrophoretic display panel of the type mentioned in the opening paragraph is described in European Patent application 01200952.8 (PHNL010161).

In the described electrophoretic display panel, each picture element has, during the display of the picture, an appearance determined by the position of the particles. The position of the particles depends, however, not only on the potential difference but also on the history of the potential difference. As a result of the application of the reset potential difference the dependency of the appearance of the picture element on the history is reduced, because particles substantially occupy one of the extreme positions. Subsequently, as a consequence of the picture potential difference, the particles occupy the position to display the picture corresponding to the image information. However, the dependency of the appearance of the picture element on the history is still relatively large and the picture being displayed differs significantly from a picture being an exact representation of the image information. Therefore, the picture being displayed has a relatively low picture quality.

It is a drawback of the described display panel that it is difficult to obtain therewith a relatively high picture quality.

It is an object of the invention to provide a display panel of the kind mentioned in the opening paragraph which is able to provide a relatively high picture quality.

The object is thereby achieved that the drive means are further arranged for controlling the reset potential difference of each picture element of at least a number of the picture elements to have an additional reset duration.

An explanation might be as follows. For at least a number of the picture elements, denoted by subset, the reset potential difference of the display panel according to the invention has an additional reset duration. Therefore, for the subset the driving force driving particles towards one of the extreme positions is present for a longer interval in the display panel according to the invention than in the display panel of the said patent application. As a result, the number of the particles that are able to occupy one of the extreme positions as a consequence of the additional reset potential difference is larger for the display panel according to the invention. Therefore, in the display panel according to the invention a larger number of the particles will have a position which is extreme and thereby predetermined prior to the application of the picture potential difference, resulting in a reduced dependency of the appearance of the picture element on the history.

It has been observed that particularly additional reset durations larger than one tenth of a reference duration largely reduce the dependency of the appearance of the picture element on the history. The reference duration of a picture element is equal to a duration to change the position of particles of the picture element from one of the extreme positions to the other one of the extreme positions. Furthermore, additional reset durations larger than three times the reference duration hardly reduce the dependency of the appearance of the picture element on the history any further compared to an additional reset durations equal to three times the reference duration, whereas these relatively large additional durations have a negative effect on e.g. the power consumption and the picture update time. Therefore, it is favorable, if the additional reset duration of each picture element of the subset is larger than one tenth of the respective reference duration and smaller than three times the respective reference duration.

It is also favorable, if each picture element is one of the number of the picture elements. Then the subset is equal to the plurality of picture elements and for each picture element of the display panel the dependency of the appearance on the history is reduced.

It is also favorable, if for each picture element the respective reset duration and the respective additional reset duration have a respective sum being substantially equal to a constant. Then the reset potential differences can be controlled relatively simply by the drive means.

It is furthermore favorable, if the display panel is able to display an estimate of the picture corresponding to the image information as a consequence of the reset potential differences, as then an observer perceives a relatively smooth transition from a picture displayed prior to the application of the reset potential differences via the estimate of the picture corresponding to the image information to the picture corresponding to the image information. To achieve this, the drive means are further arranged for controlling the reset potential difference of each picture element to enable particles to occupy the extreme position which is closest to the position of the particles which corresponds to the image information.

If the picture elements are arranged along substantially straight lines, and the picture elements have substantially equal first appearances if particles substantially occupy one of the extreme positions, and

the picture elements have substantially equal second appearances if particles substantially occupy the other one of the extreme positions, and

the drive means are further arranged for controlling the reset potential differences of subsequent picture elements along each line to enable particles to substantially occupy unequal extreme positions, the observer perceives a rather smooth transition from the picture displayed prior to the application of the reset potential differences via a picture representing an average of the first and the second appearances as a result of the reset potential differences to the picture corresponding to the image information. If e.g. the first appearance is white and the second appearance is black, the picture representing an average of the first and the second appearances represents substantially middle gray.

It is furthermore favorable, if the picture elements are arranged along substantially straight rows and along substantially straight columns being substantially perpendicular to the rows in a two-dimensional structure, each row having a predetermined first number of picture elements, each column having a predetermined second number of picture elements, and

the picture elements have substantially equal first appearances if particles substantially occupy one of the extreme positions, and

the picture elements have substantially equal second appearances if particles substantially occupy the other one of the extreme positions, and

the drive means are further arranged for controlling the reset potential differences of subsequent picture elements along each row to enable particles to substantially occupy unequal extreme positions, and

the drive means are further arranged for controlling the reset potential differences of subsequent picture elements along each column to enable particles to substantially occupy unequal extreme positions. The observer perceives a rather smooth transition from the picture displayed prior to the application of the reset potential differences via a picture representing an average of the first and the second appearances to the picture corresponding to the image information. If e.g. the first appearance is back and the second appearance is white, the picture representing an average of the first and the second appearances represents substantially middle gray, which is somewhat smoother compared to the previous embodiment.

It is furthermore favorable, if the drive means are further able to control for each picture element the potential difference to be a sequence of preset potential differences before being the reset potential difference, the sequence of preset potential differences having preset values and associated preset durations, the preset values in the sequence alternating in sign, each preset potential difference representing a preset energy sufficient to release particles present in one of said extreme positions from their position but insufficient to enable said particles to reach the other one of the extreme positions. As an advantage, the sequences of preset potential differences reduce the dependency of the appearances of the picture elements on the history of the potential difference. Such sequences of preset values are described in the non-prepublished European Patent application 02077017.8 (PBNL020441). Furthermore, it is favorable, if the drive means are further arranged for controlling the potential difference of each picture element of the number of the picture elements to be a further sequence of preset potential differences between being the reset potential difference and the picture potential difference. As an advantage, the further sequences of preset potential differences further reduce the dependency of the appearances of the picture elements on the history of the potential difference.

These and other aspects of the display panel of the invention will be further elucidated and described with reference to the drawings, in which:

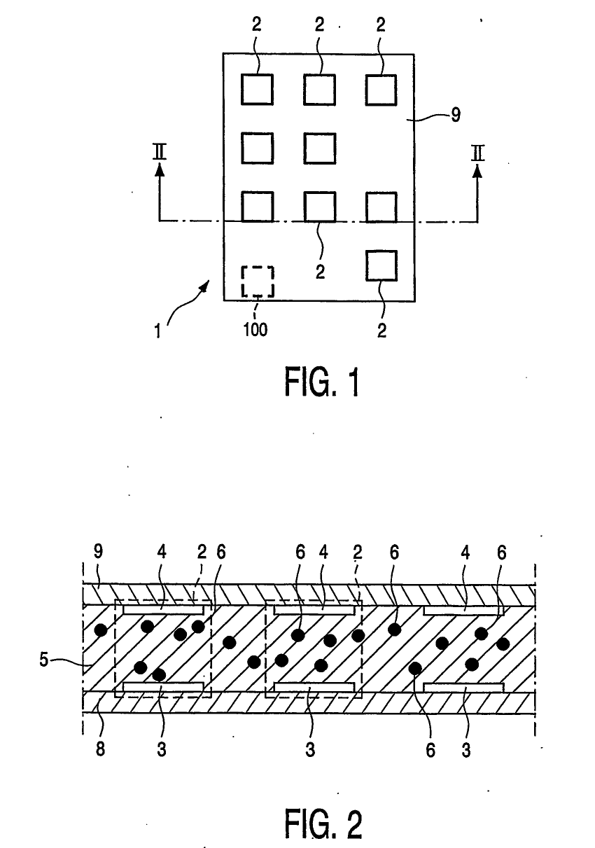

FIG. 1 shows diagrammatically a front view of an embodiment of the display panel;

FIG. 2 shows diagrammatically a cross-sectional view along II-II in FIG. 1;

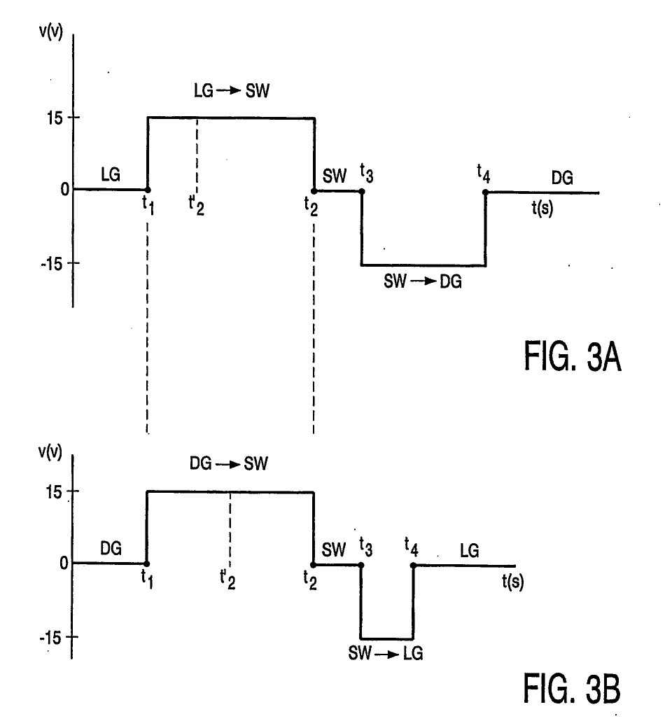

FIG. 3A shows diagrammatically the potential difference as a function of time for a picture element of the subset for the embodiment;

FIG. 3B shows diagrammatically the potential difference as a function of time for a picture element of the subset in a variation of the embodiment;

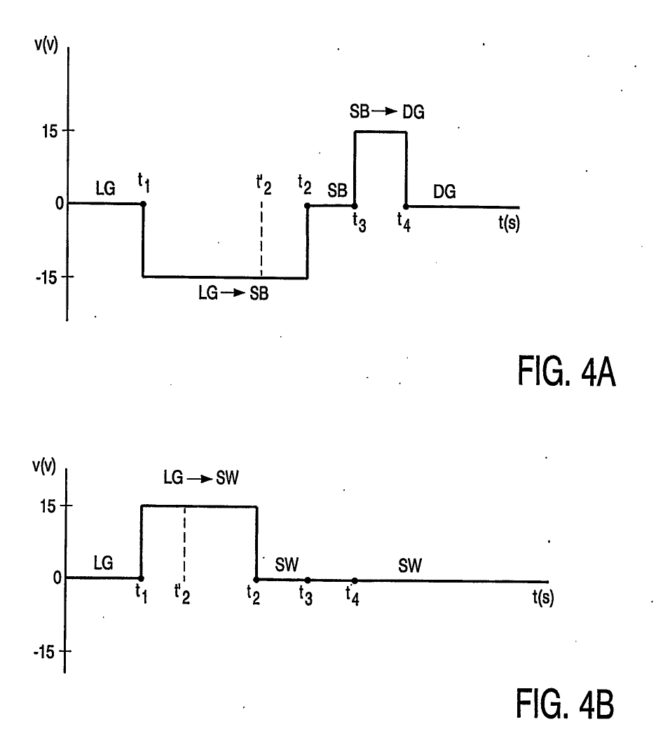

FIG. 4A shows diagrammatically the potential difference as a function of time for a picture element of the subset in another variation of the embodiment;

FIG. 4B shows diagrammatically the potential difference as a function of time for another picture element of the subset in the same variation of the embodiment associated with FIG. 4A;

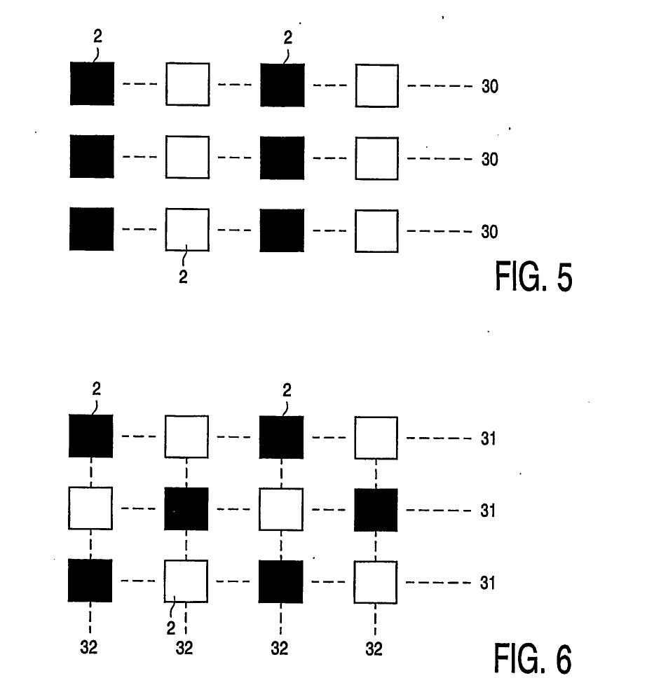

FIG. 5 shows the picture representing an average of the first and the second appearances as a result of the reset potential differences in another variation of the embodiment;

FIG. 6 shows the picture representing an average of the first and the second appearances as a result of the reset potential differences in another variation of the embodiment;

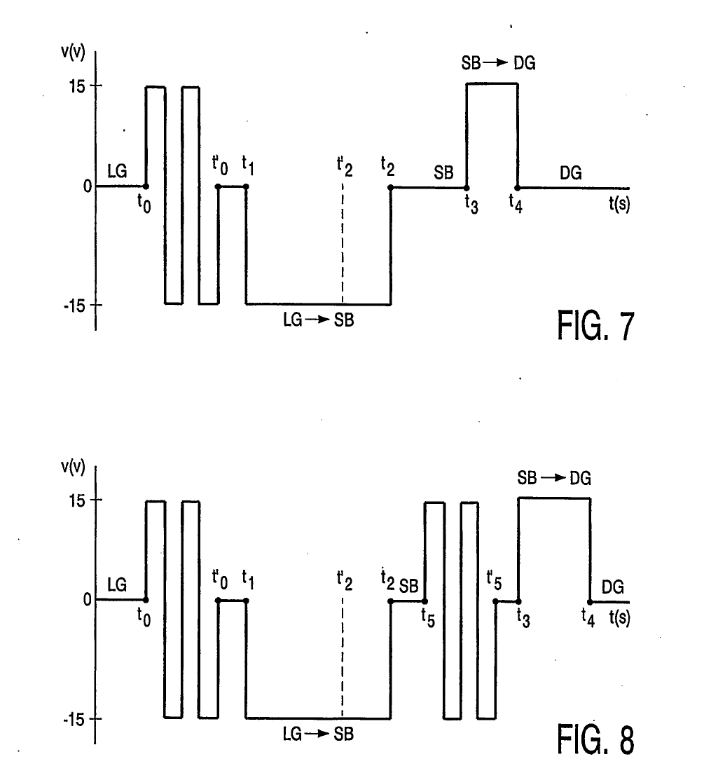

FIG. 7 shows diagrammatically the potential difference as a function of time for a picture element of the subset in another variation of the embodiment, and

FIG. 8 shows diagrammatically the potential difference as a function of time for a picture element of the subset in another variation of the embodiment.

In all the Figures corresponding parts are referenced to by the same reference numerals.

FIGS. 1 and 2 show the embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3,4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a picture potential difference for enabling the particles 6 to occupy the position corresponding to the image information. Furthermore, the drive means 100 are arranged for controlling the reset potential difference of each picture element 2 of the subset to have an additional reset duration.

As an example the appearance of a picture element 2 of the subset is light gray, denoted as LG, before application of the reset potential difference. Furthermore, the picture appearance corresponding to the image information of the picture element 2 is dark gray, denoted as DG. For this example, the potential difference of the picture element 2 is shown as a function of time in FIG. 3. The reset potential difference has e.g. a value of 15 Volts and is present from time t1 to time t2, the portion from time t1 to time t2′ being the reset duration and the portion from time t2′ to time t2 being the additional reset duration. The reset duration and the additional reset duration are e.g. 50 ms and 250 ms, respectively. As a result the picture element 2 has an appearance being substantially white, denoted as SW. The picture potential difference is present from time t3 to time t4 and has a value of e.g. −15 Volts and a duration of e.g. 150 ms. As a result the picture element 2 has an appearance being dark gray, for displaying the picture. The interval from time t2 to time t3 may be absent.

The reference duration for each picture element 2 of the subset is equal to the duration to change the position of particles 6 of the respective picture element 2 from one of the extreme positions to the other one of the extreme positions. For the picture element 2 in the example the reference duration is e.g. 200 ms. In a variation of the embodiment the additional reset duration of each picture element 2 of the subset is larger than one tenth of the respective reference duration and smaller than three times the respective reference duration.

It is favorable, if the subset is equal to the plurality of picture elements 2. Then, for each picture element 2 of the display panel the dependency of the appearance on the history is reduced.

In a further variation of the embodiment for each picture element 2 the respective reset duration and the respective additional reset duration have a respective sum being substantially equal to a constant. As an example the potential difference of a picture element 2 in this variation is shown as a function of time in FIG. 3B. The appearance of the picture element 2 is dark gray before application of the reset potential difference. Furthermore, the picture appearance corresponding to the image information of the picture element 2 is light gray. The reset potential difference has e.g. a value of 15 Volts and is present from time t1 to time t2. The reset duration and the additional reset duration are e.g. 150 ms and 150 ms, respectively. As a result the picture element 2 has an appearance being substantially white. The picture potential difference is present from time t3 to time t4 and has e.g. a value of e.g. −15 Volts and a duration of e.g. 50 ms. As a result the picture element 2 has an appearance being light gray, for displaying the picture. The sum of the reset duration and the additional reset duration of the reset potential difference of the picture element 2 associated with FIG. 3A is equal to the sum of the reset duration and the additional reset duration of the reset potential difference of the picture element 2 associated with FIG. 3B, and equal to the constant, in this example being 300 ms.

In another variation of the embodiment the drive means 100 are further arranged for controlling the reset potential difference of each picture element 2 to enable particles 6 to occupy the extreme position which is closest to the position of the particles 6 which corresponds to the image information. As an example the appearance of a picture element 2 is light gray before application of the reset potential difference. Furthermore, the picture appearance corresponding to the image information of the picture element 2 is dark gray. For this example, the potential difference of the picture element 2 is shown as a function of time in FIG. 4A. The reset potential difference has e.g. a value of −15 Volts and is present from time t1 to time t2. The reset duration and the additional reset duration are e.g. 150 ms and 100 ms, respectively. As a result, the particles 6 occupy the second extreme position and the picture element 2 has a substantially black appearance, denoted as SB, which is closest to the position of the particles 6 which corresponds to the image information, i.e. the picture element 2 having a dark gray appearance. The picture potential difference is present from time t3 to time t4 and has e.g. a value of e.g. 15 Volts and a duration of e.g. 50 ms. As a result the picture element 2 has an appearance being dark gray, for displaying the picture. As another example the appearance of another picture element 2 is light gray before application of the reset potential difference. Furthermore, the picture appearance corresponding to the image information of this picture element 2 is substantially white. For this example, the potential difference of the picture element 2 is shown as a function of time in FIG. 4B. The reset potential difference has e.g. a value of 15 Volts and is present from time t1 to time t2. The reset duration and the additional reset duration are e.g. 50 ms and 100 ms, respectively. As a result, the particles 6 occupy the first extreme position and the picture element 2 has a substantially white appearance, which is closest to the position of the particles 6 which corresponds to the image information, i.e. the picture element 2 having a substantially white appearance. The picture potential difference is present from time t3 to time t4 and has a value of 0 Volts because the appearance is already substantially white, for displaying the picture.

In FIG. 5 the picture elements 2 are arranged along substantially straight lines 30. The picture elements 2 have substantially equal first appearances, e.g. white, if particles 6 substantially occupy one of the extreme positions, e.g. the first extreme position. The picture elements 2 have substantially equal second appearances, e.g. black, if particles 6 substantially occupy the other one of the extreme positions, e.g. the second extreme position. The drive means 100 are further arranged for controlling the reset potential differences of subsequent picture elements 2 along on each line 30 to enable particles 6 to substantially occupy unequal extreme positions. FIG. 5 shows the picture representing an average of the first and the second appearances as a result of the reset potential differences. The picture represents substantially middle gray.

In FIG. 6 the picture elements 2 are arranged along substantially straight rows 31 and along substantially straight columns 32 being substantially perpendicular to the rows in a two-dimensional structure, each row 31 having a predetermined first number of picture elements 2, e.g. 4 in FIG. 6, each column 32 having a predetermined second number of picture elements 2, e.g. 3 in FIG. 6. The picture elements 2 have substantially equal first appearances, e.g. white, if particles 6 substantially occupy one of the extreme positions, e.g. the first extreme position. The picture elements 2 have substantially equal second appearances, e.g. black, if particles 6 substantially occupy the other one of the extreme positions, e.g. the second extreme position. The drive means 100 are further arranged for controlling the reset potential differences of subsequent picture elements 2 along on each row 31 to enable particles 6 to substantially occupy unequal extreme positions, and the drive means 100 are further arranged for controlling the reset potential differences of subsequent picture elements 2 along on each column 32 to enable particles 6 to substantially occupy unequal extreme positions. FIG. 6 shows the picture representing an average of the first and the second appearances as a result of the reset potential differences. The picture represents substantially middle gray, which is somewhat smoother compared to the previous embodiment.

In another variation of the embodiment the drive means 100 are further arranged for controlling the potential difference of each picture element 2 of the number to be a sequence of preset potential differences before being the reset potential difference. Furthermore, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element 2 is light gray before the application of the sequence of preset potential differences. Furthermore, the picture appearance corresponding to the image information of the picture element 2 is dark gray. For this example, the potential difference of the picture element 2 is shown as a function of time in FIG. 7. In the example, the sequence of preset potential differences has 4 preset values, subsequently 15 Volts, −15 Volts, 15 Volts and −15 Volts, applied from time t0 to time t0′. Each preset value is applied for e.g. 20 ms. The time interval between t0′ and t1 is negligibly small. Subsequently, the reset potential difference has e.g. a value of −15 Volts and is present from time t1 to time t2. The reset duration and the additional reset duration are e.g. 150 ms and 50 ms, respectively. As a result, the particles 6 occupy the second extreme position and the picture element 2 has a substantially black appearance. The picture potential difference is present from time t3 to time t4 and has e.g. a value of e.g. 15 Volts and a duration of e.g. 50 ms. As a result the picture element 2 has an appearance being dark gray, for displaying the picture. In another variation the drive means 100 are further arranged for controlling the potential difference of each picture element 2 of the number of the picture elements 2 to be a further sequence of preset potential differences between being the reset potential difference and the picture potential difference. As an example the appearance of a picture element 2 is light gray before the application of the sequence of preset potential differences. Furthermore, the picture appearance corresponding to the image information of the picture element 2 is dark gray. For this example, the potential difference of the picture element 2 is shown as a function of time in FIG. 8. In the example, the sequence of preset potential differences and the reset potential difference are e.g. equal to the respective potential differences as shown in FIG. 7. As a result, the particles 6 occupy the second extreme position and the picture element 2 has a substantially black appearance. In the example, the further sequence of preset potential differences has e.g. 4 preset values, subsequently 15 Volts, −15 Volts, 15 Volts and −15 Volts, applied from time t5 to time t5′. Each preset value is applied for e.g. 20 ms. The number of preset potential differences, the preset values and the associated preset durations in the further sequence can be chosen independently from the number of preset potential differences, the preset values and the associated preset durations in the sequence. The time intervals between t2 and t5 and between t5′ and t3 can be negligibly small. The picture potential difference is present from time t3 to time t4 and has e.g. a value of e.g. 15 Volts and a duration of e.g. 50 ms. As a result the picture element 2 has an appearance being dark gray, for displaying the picture.

1. An electrophoretic display panel (1), for displaying a picture corresponding to image information, comprising:
an electrophoretic medium (5) comprising charged particles (6);
a plurality of picture elements (2);
a first and a second electrode (3,4) associated with each picture element (2) for receiving a potential difference; and
drive means (100),
the charged particles (6) being able to occupy a position being one of extreme positions near the electrodes (3,4) and intermediate positions in between the electrodes (3,4) for displaying the picture, and
the drive means (100) being arranged for controlling the potential difference of each picture element (2)
to be a reset potential difference having a reset value and a reset duration for enabling particles (6) to substantially occupy one of the extreme positions, and subsequently
to be a picture potential difference for enabling the particles (6) to occupy the position corresponding to the image information,
characterized in that
the drive means (100) are further arranged for controlling the reset potential difference of each picture element (2) of at least a number of the picture elements (2) to have an additional reset duration.

2. A display panel (1) as claimed in claim 1 characterized in that each additional reset duration is larger than one tenth of a reference duration and smaller than three times the reference duration, the reference duration being equal to a duration to change the position of particles (6) of the respective picture element (2) from one of the extreme positions to the other one of the extreme positions.

3. A display panel (1) as claimed in claim 1 characterized in that each picture element (2) is one of the number of the picture elements (2).

4. A display panel (1) as claimed in claim 3 characterized in that for each picture element (2) the respective reset duration and the respective additional reset duration have a respective sum being substantially equal to a constant.

5. A display panel (1) as claimed in claim 1 characterized in that the drive means (100) are further arranged for controlling the reset potential difference of each picture element (2) to enable particles (6) to occupy the extreme position which is closest to the position of the particles (6) which corresponds to the image information.

6. A display panel (1) as claimed in claim 3 characterized in that the picture elements (2) are arranged along substantially straight lines (30), and
the picture elements (2) have substantially equal first appearances if particles (6) substantially occupy one of the extreme positions, and
the picture elements (2) have substantially equal second appearances if particles (6) substantially occupy the other one of the extreme positions, and
the drive means (100) are further arranged for controlling the reset potential differences of subsequent picture elements (2) along each line (30) to enable particles (6) to substantially occupy unequal extreme positions.

7. A display panel (1) as claimed in claim 3 characterized in that the picture elements (2) are arranged along substantially straight rows (31) and along substantially straight columns (32) being substantially perpendicular to the rows (31) in a two-dimensional structure, each row (31) having a predetermined first number of picture elements (2), each column (32) having a predetermined second number of picture elements (2), and
the picture elements (2) have substantially equal first appearances if particles (6) substantially occupy one of the extreme positions, and
the picture elements (2) have substantially equal second appearances if particles (6) substantially occupy the other one of the extreme positions, and
the drive means (100) are further arranged for controlling the reset potential differences of subsequent picture elements (2) along each row (31) to enable particles (6) to substantially occupy unequal extreme positions, and
the drive means (100) are further arranged for controlling the reset potential differences of subsequent picture elements (2) along each column (32) to enable particles (6) to substantially occupy unequal extreme positions.

8. A display panel (1) as claimed in claim 1 characterized in that the drive means (100) are further arranged for controlling the potential difference of each picture element (2) of the number of the picture elements (2) to be a sequence of preset potential differences before being the reset potential difference, the sequence of preset potential differences having preset values and associated preset durations, the preset values in the sequence alternating in sign, each preset potential difference representing a preset energy sufficient to release particles (6) present in one of said extreme positions from their position but insufficient to enable said particles (6) to reach the other one of the extreme positions.

9. A display panel (1) as claimed claim 8 characterized in that the drive means (100) are further arranged for controlling the potential difference of each picture element (2) of the number of the picture elements (2) to be a further sequence of preset potential differences between being the reset potential difference and the picture potential difference.
